(19) United States
(12) Patent Application Publication
(10) Pub. No.: US 2006/0119320 A1
(43) Pub. Date: Jun. 8, 2006

(54) Current control circuitry and methodology for controlling current from current source

(75) Inventors: Samuel H. Nork, Andover, MA (US); Trevor W. Barcelo, Andover, MA (US); Roger A. Zemke, Londonderry, NH (US); John Shannon, Los Gatos, CA (US)

Correspondence Address: MCDERMOTT WILL & EMERY LLP, 600 13TH STREET, N.W., WASHINGTON, DC, 20005-3096, US

(73) Assignee: LINEAR TECHNOLOGY CORPORATION

(21) Appl. No.: 11/119,936

(22) Filed: May 3, 2005

Related U.S. Application Data
(60) Provisional application No. 60/632,690, filed on Dec. 3, 2004.

(51) Int. Cl. H02J 7/00

(52) U.S. Cl. 320/128

(57) ABSTRACT

Current control circuitry for controlling current supplied from a current source to a load and a battery. A circuit path connects the source and the load. Current on the circuit path is limited to a predetermined amount. A voltage on the circuit path is monitored and in response, current to be supplied to the battery from the circuit path is controlled so as to maintain the current on the circuit path within the predetermined amount.

### TECHNICAL FIELD

Embodiments described below relate generally to current control circuitry for controlling total current to be supplied from a source, which may be a limited current capacity source, to a load and a battery. Specifically, the embodiments relate to circuitry for monitoring a voltage to a load to control an amount of current to be supplied to a battery so as to maintain the total current within a predetermined amount.

1. Description of Related Art

Rechargeable batteries are commonly used to power portable electronic devices, such as laptop computers, PDAs, digital cameras and MP3 players. Many of those portable electronic devices include circuitry for charging their batteries whenever the devices are connected to external power sources such as a wall adapter, USB, Firewire, and Ethernet. For example, the USB itself can be used to directly power the devices and charge their batteries. According to the USB specification, USB hosts, or USB powered hubs, provide as much as 500 mA from their nominal 5V supply. The USB is known as a limited current capacity source.

FIG. 1 shows an example of a schematic circuit topology for providing power to a load and charging a battery, incorporated into a portable USB device. As shown in FIG. 1, a USB linear charger 2 generally provides current limited power directly to a battery 4 to which a system load 6 is tied in parallel with battery 4. This topology maintains the USB current constrain but sacrifices efficiency in that there is a substantial voltage drop from USB input voltage to battery voltage. Since load 6 is tied directly to battery 4, if the battery voltage is very low or battery 4 is dead, there will not be enough voltage to be applied to load 6 to run an application. The voltage input to system load 6 is the battery voltage and the current drawn by system load 6 is equal to the power requirement of load 6 divided by the battery voltage. This is true even if there is external power applied to load 6 and battery 4 because the battery dictates the voltage to be applied to load 6. When battery 4 is fully discharged, several minutes of charging may be required before any load can be connected to the battery. Moreover, many battery or handheld applications have peak current that can exceed the 500 mA USB specification. Input current from the limited current source to USB linear charger 2 needs to be controlled properly when peak current of load 6 exceeds the USP specification. The subject matter described herein addresses, but is not limited to, the above shortcomings.

2. Summary of the Disclosure

Embodiments detailed herein describe current control circuitry and methodology for controlling current from a source, which may be a limited current capacity source, such as USB, to a load and a battery. In one aspect of the disclosure, the circuitry may include a circuit path for interconnecting the source and the load. The circuitry may further include a first circuit configured for limiting current on the circuit path within a predetermined amount. There may also be a second circuit, through which the battery is connected to the circuit path, configured for monitoring a voltage on the circuit path, and in response controlling an amount of current from the circuit path to the battery so as to maintain the current on the circuit path within the predetermined amount.

In one embodiment, the second circuit may be configured for monitoring a voltage drop from the source to the load, and reducing the amount of the current to be supplied to the battery when the voltage drop exceeds a predetermined voltage. The second circuit can also be configured for monitoring a voltage of the load, and reducing the amount of the current to be supplied to the battery when the load voltage drops below a predetermined voltage.

In addition, the second circuit may be configured for monitoring a voltage of the battery, and reducing the amount of the current to be supplied to the battery when the battery voltage reaches a predetermined voltage. The second circuit may further be configured for monitoring a voltage of the load and a voltage of the battery, and enabling the battery to provide current to the load when the load voltage drops below the battery voltage.

In another embodiment, the circuitry may include a detector for detecting presence of an additional source connected to the circuit path for supplying current to the load and battery. In this embodiment, the first circuit may be configured for turning off the current from the source when the presence of the additional source is detected, for allowing the additional source to supply the current to the load and battery.

In another aspect, the circuitry may include a circuit path for interconnecting the source and the load. The circuitry may further include a first circuit configured for limiting current on the circuit path within a predetermined amount, and a second circuit, through which the battery is connected to the circuit path, configured for monitoring a voltage on the circuit path, and in response controlling an amount of current from the first circuit to the battery so as to maintain the current on the circuit path within the predetermined amount. In the circuitry, the first circuit may include a current limit control FET, which attains a high impedance once current on the circuit path reaches the predetermined amount, thereby causing the voltage on the circuit path to drop below an internally set threshold.

In yet another aspect, the methodology may control current supplied from a source to a load and a battery, in which a circuit path interconnects the source and the load, and the battery is connected to the circuit path through a battery current control circuit for controlling current to the battery. Current on a circuit path for interconnecting the source and the load may be limited within a predetermined amount. A voltage on the circuit path may be monitored, and in response an amount of current from the circuit path to the battery through the battery current control circuit may be controlled so as to maintain the current on the circuit path within the predetermined amount.

Additional aspects and advantages of the present disclosure will become readily apparent to those skilled in the art from the following detailed description, wherein only exemplary embodiments of the present disclosure is shown and described, simply by way of illustration of the best mode contemplated for carrying out the present disclosure. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### BRIEF DESCRIPTION OF THE DRAWINGS

Examples of the subject matter claimed herein are illustrated in the figures of the accompanying drawings and in which reference numerals refer to similar elements and in which:

FIG. 1 shows an example of a schematic circuit topology for providing power to a load and charging a battery, incorporated into a portable USB device.

FIG. 2 is an exemplary circuit diagram showing a basic configuration of current control circuitry for controlling current from a limited current capacity source to a load and battery according to one embodiment of the disclosure.

FIG. 3 is an exemplary circuit diagram showing one embodiment of the current control circuitry implemented in FIG. 2.

### DESCRIPTION OF THE EMBODIMENT

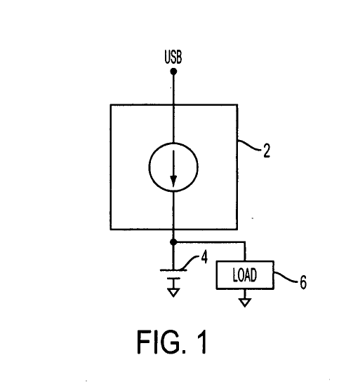

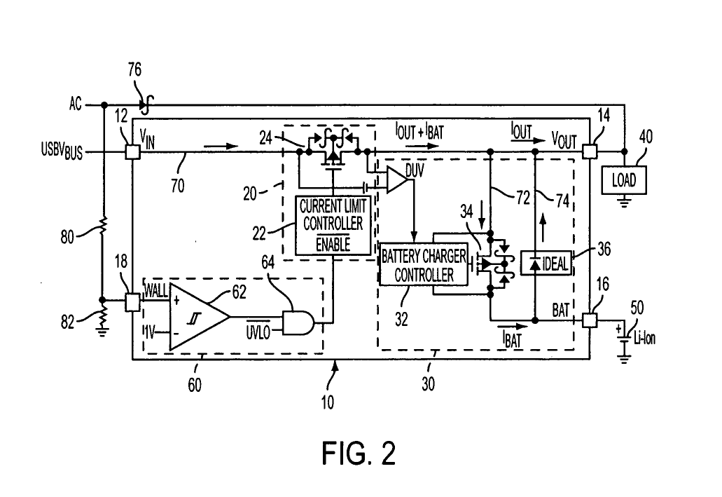

FIG. 2 shows one embodiment of current control circuitry for controlling current from a limited current capacity source to a load and a battery. In this embodiment, the limited current capacity source may be a USB. Current control circuitry 10 shown in FIG. 1 serves, but is not limited to serving, as a USB power manager and Li-Ion battery charger designed to work in portable battery-powered USB application. Current control circuitry 10 may be formed on a single chip and incorporated into the portable battery-powered applications.

Current control circuitry 10 may be configured to steer a load 40 to an available source of power, and charging battery 50 with any available leftover current. In this embodiment, a USB (VBUS), a wall adaptor AC and battery 50 are sources of power available to load 40. When the USB is present, circuitry 10 connects USB power directly to load 40 on circuit path 70. When both the USB and wall adapter AC are present, the circuitry may select wall adapter AC to supercede the USB as the source of power. These direct connections to load 40 translate to higher load voltages and greater efficiency.

USB hosts, or USB powered hubs, provide as much as 500 mA from their nominal 5V supply. To run load 40 at as high an input voltage as possible minimizes current draw from the circuit path 70—leaving more current for battery charging. Current control circuitry 10 in this embodiment has a topology that switches battery 50 out of circuit path 70 when it is not needed. The greater efficiency of running load 40 at the USB supply voltage (instead of the battery voltage, see FIG. 1) means there is more current left in the 500 mA USB budget for charging battery 50. Because battery 50 is not in circuit path 70 whereas load 40 is tied to the USB or wall adapter AC, load 40 can be powered even if battery 50 is low or dead. The same reasoning applies for a fully charged battery 50. Even fully charged battery 50 is not in circuit path 70 unless the USB or the wall adapter is removed, as explained below (an ideal diode mode).

Current control circuitry 10 has a unique current control scheme that maintains the USB current limited while charging a battery under varying load conditions. In this current control scheme, current control circuitry 10 monitors a voltage on circuit path 70, and in response, increases or decreases current for battery charging to maintain the USB current limited.

Referring to FIG. 2, current control circuitry 10 may include an input terminal 12 connected to a USB supply VBUS. Input current from input terminal 12 is limited, as described below. An output terminal 14 is used to provide controlled power to load 40 from either USB supply VBUS or battery 16 when the USB supply is not present. Output terminal 14 can also be used as an input for charging battery 50 when the USB supply is not present, but power from wall adapter AC is applied to the terminal through a unidirectional current device such as a Schottky diode 76. Input terminal 12 and output terminal 14 are interconnected by circuit path 70. A battery terminal 16, to which battery 50 is connected, is connected to circuit path 70 through a battery charger control block 30 (explained below). Battery terminal 16 is used as an output when charging battery 50 and as an input when supplying battery power to output terminal 14. An example of battery 50 is a Li-ion battery, but not limited to it.

Current control circuitry 10 may include a current limit control block 20 provided between input terminal 12 and output terminal 14. Current limit control block 20 includes a current limit controller 22 configured for controlling an FET 24 in order to limit the sum of current (“total current I_{OUT}+I_{BAT}”) to load 40 (“output current I_{OUT}”) and current to battery 50 (“battery current I_{BAT}”) to an input current limit I_{LIM} Input current limit I_{LIM} may be externally programmed.

Current control circuitry 10 also includes a battery charger block 30 which switches battery 50 out of circuit path 70. Accordingly, battery 50 does not dictate a voltage on circuit path 70. Battery charger block 30 has a battery charger controller 32 configured for monitoring output voltage V_{OUT} on circuit path 70 or output terminal 14, and in response controlling an FET 34 to increase or decrease an amount of battery charge current I_{BAT} to be supplied to battery 50. Battery charger controller 32 controls battery charge current I_{BAT} for battery 50 to maintain total current I_{OUT}+I_{BAT} within a predetermined amount (input current limit I_{LIM}) limited by current limit control block 20. The voltage on circuit path 70 or output terminal 14 is considered as a function of the amount of total current I_{OUT}+I_{BAT} to be supplied to load 40 and battery 50.

Battery charger block 30 further includes an ideal diode function 36, implementation of which is well known, for example in commercially available LTC 4413 dual ideal diode integrated circuit, manufactured by Linear Technology Corporation, and described in its corresponding datasheet, incorporated herein by reference. When output voltage V_{OUT} drops below a battery voltage V_{BAT}, ideal diode function 36 will then start to conduct and prevent output voltage V_{OUT} from dropping below battery voltage V_{BAT} through ideal diode path 74. Ideal diode function 36 may use FET 34 to connect battery 50 to circuit path 70. Ideal diode function 36 also prevents reverse conduction from load 40 to battery 50 when output voltage V_{OUT} is greater than battery voltage V_{BAT}.

In short, battery charger block 30 is provided to monitor output voltage V_{OUT} and adjust the current flowing into and out of battery terminal 16 such that load 40 is always powered and the battery charge current I_{BAT} is as close to a programmed amount as operating conditions allow.

In addition, there is a power source switching block 60 including an hysteretic comparator 62 and an AND gate 64. Power source switching block 60 is configured for detecting presence of an external alternative power source, such as wall adapter AC. When wall adapter AC is detected, power source switching block 60 disables current limit control block 20 to prevent reverse conduction from output terminal 14 to input terminal 12.

Operation of current control circuitry 10 under USB supply V_{BUS} (current limited source) will now be explained. Current control circuitry 10 enables simultaneous powering of load 40 and charging of battery 50 from USB supply V_{BUS} with input current limit I_{LIM} limited by current limit control block 20. Current limit controller 22 controls FET 24 to limit total current I_{OUT}+I_{BAT} to the predetermined amount according to the USB specification. This predetermined amount is input current limit I_{LIM}.

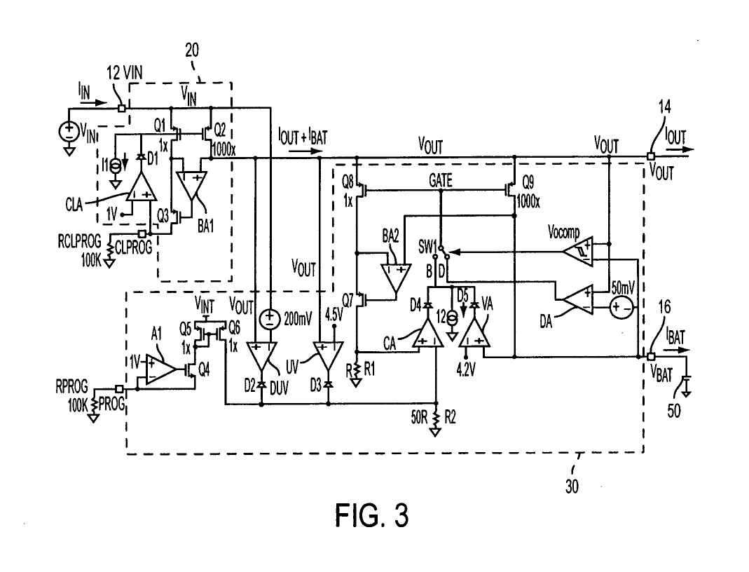

Battery charger controller 32 monitors output voltage V_{OUT} to determine if output voltage V_{OUT} is equal to an input voltage V_{IN} on input terminal 12 minus a IR drop across FET 24 in current limit control block 20 by using an amplifier DUV (see FIG. 3 and discussion later herein for more detail). If output voltage V_{OUT} is equal to input voltage V_{IN} minus the IR drop, no current adjustment is made by battery charger controller 32. In this case, total current I_{OUT}+I_{BAT} is equal to or less than input current limit I_{LIM}. However, if battery charger controller 32 determines that output voltage V_{OUT} is less than input voltage V_{IN} minus the IR drop, the controller will then reduce battery charge current I_{BAT} so that total current I_{OUT}+I_{BAT} becomes equal to or less than input current limit I_{LIM} The reason output voltage V_{OUT} drops when total current I_{OUT}+I_{BAT} exceeds input current limit I_{LIM} is that FET 24 in current limit control block 20 acts as a high impedance once total current I_{OUT}+I_{BAT} reaches input current limit I_{LIM}. When output voltage V_{OUT} drops below an internally set threshold, battery charger controller 32 reduces battery charge current I_{BAT} in order to maintain total input current I_{OUT}+I_{BAT} within input current limit I_{LIM}.

For example, battery charger controller 32 may begin to reduce battery current I_{BAT} for charging battery 50 once output voltage V_{OUT} drops to 4.5V (for this example). By the time voltage V_{OUT} reaches, for example, 4.3V, it may be possible to completely turn off battery charge current I_{BAT}. When output current I_{OUT} to load 40 is less than input current limit I_{LIM}, output voltage V_{OUT} may in effect be regulated to a voltage between 4.3V and 4.5V by battery charger controller 32 (for this example).

When output voltage V_{OUT} drops below battery voltage V_{BAT}, that is, output current I_{OUT} alone exceeds input current limit I_{LIM}, output voltage V_{OUT} will continue to fall. Ideal diode function 36 in battery charger control block 30 connects circuit path 70 and battery path 74 to supply current to load 40 from battery 50.

When presence of wall adaptor AC is sensed by power source switching block 60, the block shuts off circuit path 70 from input terminal 12 to output terminal 14. Load 40 receives its power directly from wall adaptor AC and battery 50 is charged off of output terminal 14.

The positive input of comparator 62 in power source switching block 60 is connected to wall adapter AC through a wall terminal 18, and is applied with a voltage divided by resistors 80 and 82. Comparator 62 compares the divided voltage with a voltage of 1V (for this example) applied to its negative input. If the divided voltage is greater than 1V and a signal UVLO (active low) becomes logic high, the output of AND gate 64 will then be logic high. Therefore, current limit controller 22 is disabled, and load 40 receives power from wall adaptor AC through Schottky diode 76. At this time, output terminal 14 serves as an input terminal for battery 50. Therefore, power is supplied to battery 50 through output terminal 14 and battery charge path 72 for charging battery 50.

When there is no input power, such as USB Supply V_{BUS} or wall adapter AC, available, ideal diode function 36 is enabled and the forward conduction of the diode prevents output voltage V_{OUT} from dropping below battery voltage V_{BAT}. That is, power is supplied to load 40 from battery 50.

FIG. 3 illustrates detailed configuration of current limit control block 20 and battery charger control block 30 in this embodiment. Current limit control block 20 is programmed by an external resistor Rclprog connected thereto through a terminal Clprog. Input current limit I_{LIM} can be programmed by this resistor Rclprog. For instance, resistor Rclprog may be 100 kΩ in this embodiment. Resister Rclprog is connected to the positive input of an amplifier CLA, whose negative input is supplied with, for example, a voltage of 1V. Amplifier CLA works against a current source I1 through a diode D1, and forces current through FET Q1 to equal 1V/100 kΩ. FET Q1 constitutes a current mirror with a FET Q2. For example, the ratio of FETs Q1 and Q2 is a precise 1:1000 ratio which forces the output current of FET Q2 to equal 1000 times the current in FET Q1. The current from FET Q2 shows input current limit I_{LIM} FET Q2 corresponds to FET 24 in FIG. 2.

Current limit control block 20 further includes an amplifier BA1 and a FET Q3 which form a loop to ensure that the drain voltages of FETs Q1 and Q2 are equal, thereby minimizing output impedance mismatch errors in FETs Q1 and Q2.

Current limit control block 20 acts as a very accurate programmable current source. Output terminal 14 is connected directly to the output of this very high output impedance current source, current limit control block 20, and supplies current to both load 14 and battery charger control block 30. If total current I_{OUT}+I_{BAT} is less than input current limit I_{LIM} of current limit control block 20, then the voltage of output terminal 14 is approximately equal to the voltage of input terminal 12 minus a voltage drop of FET Q2. The output impedance of current limit control block 20 formed by FETs Q1 and Q2, and amplifiers CLA and BA1 is very high. Accordingly, if total current I_{OUT}+I_{BAT} exceeds input current limit I_{LIM}, the voltage on output terminal 14 collapses immediately until the total current I_{OUT}+I_{BAT} matches input current limit I_{LIM} In this case, battery charger control block 30 reduces battery charge current I_{BAT} such that total current I_{OUT}+I_{BAT} does not exceed input current limit I_{LIM}.

Battery charger control block 30 operates in one of two modes: a charge mode and an ideal diode mode, as described above. Battery charger control block 30 switches the operation mode depending on an output state of a comparator Vocomp which compares output voltage V_{OUT} with battery voltage V_{BAT}. If output voltage V_{OUT} is greater than battery voltage V_{BAT}, the block will then enter into the charge mode and control a switch SW1 to connect a node B to a node GATE connected to both FETs Q8 and Q9. FET Q9 corresponds to FET 34 in FIG. 2. If output voltage V_{OUT} is less than battery voltage V_{BAT}, the block will enter into the ideal diode mode and control switch SW1 to connect a node D to node GATE.

In the charge mode, a nominal battery charge current is programmed by an external resistor Rprog of, for example, 100 kΩ, connected to the block through a terminal Prog. Resistor Rprog is connected to the negative terminal of an amplifier A1 whose positive terminal is provided with, for example, a voltage of 1V. Amplifier A1 forces the fixed 1V across resistor Rprog which creates current equal to 1V/100 kΩ flowing through FET Q4 and into FETs Q5 and Q6 constituting a 1:1 current mirror. The sources of FETs Q5 and Q6 are connected to a voltage source V_{INT}. Current coming out of the drain of FET Q6 is a reference for a current control amplifier CA whose positive input is connected to a resistor R1 and negative input is connected to a resistor R2. Resistors R1 and R2 have a 1:50 ratio in this example. Amplifier CA pulls up on node GATE through a diode D4 until voltage across resistor R1 equals voltage across resistor R2. Due to these resistors having the 1:50 ratio, current through FET Q8 and resistor R1 equals 50 times current in resistor R2. FETs Q8 and Q9 form 1:1000 current mirror in this example. Current flowing out of FET Q9 is battery charge current I_{BAT} going into battery 50 through battery terminal 16. Amplifier BA2 and a follower FET Q7 compensate for output impedance errors between FETs Q8 and Q9, and ensure that the current ratio is fixed at, e.g., 1:1000. Accordingly, in this example, the nominal battery current is 50,000 times the current flowing through program resistor Rprog.

Amplifier VA is a voltage control amplifier used in the charge mode to reduce battery charge current I_{BAT} into battery 50 once battery voltage V_{BAT} reaches, for example, 4.2V.

Amplifiers DUV (see FIG. 2) and UV are provided to reduce current flowing through FETs Q8 and Q9 only if the following conditions are met. When amplifiers DUV and UV do not detect conditions that require reduction of battery charge current I_{BAT}, battery charger control block 30 operates with its nominal current driving accuracy. In this embodiment, for example, FET Q2 is sized such that a 150 mV drop across FET Q2 corresponds to maximum allowed input current limit I_{LIM} FET Q2 carries both output current I_{OUT} and battery current I_{BAT} when the block is in the charge mode. A 200 mV drop across FET Q2 will only occur once total current I_{OUT}+I_{BAT} exceeds input current limit I_{LIM}. Amplifier DUV has a built-in 200 mV (in this example) current limit detect offset connected to its negative terminal, and will begin sinking current through a diode D2 once input voltage V_{IN} to output voltage V_{OUT} drop exceeds 200 mV. Current that flows through diode D2 reduces current flowing in resistor R2, thereby reducing current flowing in FETs Q8 and Q9 from the nominal value of battery charge current I_{BAT} in order to limit the total current I_{OUT}+I_{BAT} within input current limit I_{LIM}.

It is also possible to make such a current limit detect offset adaptive in order to account for different programmed values for input current limit I_{LIM} (not shown in FIG. 3). This would require adjusting the current limit detect offset as a function of programmed input current limit I_{LIM} to account for the fixed ON resistance of FET Q2.

Similarly, if output voltage V_{OUT} on output terminal 14 drops to 4.5V, for example, amplifier UV will reduce current in FET Q6 through a diode D3, thereby reducing battery charge current I_{BAT} to in effect regulate output voltage V_{OUT} to 4.5V in this example and prevent output voltage V_{OUT} from dropping further due to impedance or an external current limit in the input supply (output terminal V_{OUT} acts as an input terminal for battery 50).

It is noted that either amplifier DUV or amplifier UV can sink enough current to completely turn off battery charge current I_{BAT}.

If output current I_{OUT} to load 40 by itself exceeds input current limit I_{LIM}, output voltage V_{OUT} will drop until output voltage V_{OUT} is less than battery voltage V_{BAT}. At this point, amplifier Vocomp switches the operation mode from the charge mode to the ideal diode mode by controlling switch SW1 to connect node GATE to an amplifier DA through node D. Therefore, amplifier DA regulates a voltage across FET Q9 to battery voltage V_{BAT} minus 50 mV.

As explained above, current control circuitry 10 includes current limit control block 20 and battery charger control block 30 which monitors output voltage V_{OUT}, and reduces battery charge current I_{BAT} as needed to accurately maintain total current I_{OUT}+I_{BAT} constant. Current control circuitry 10 provides improved charge current accuracy under current limited conditions. In addition, battery current I_{BAT} is reduced by amplifier DUV without requiring a significant voltage drop in output voltage V_{OUT}, which will maximize the power available to load 40 even under current limited conditions. Further, according to power source switching block 60, the circuitry is allowed to work seamlessly with wall adapter AC connected directly to output terminal 14 without battery current oscillations.

Having described embodiments, it is noted that modifications and variations can be made by persons skilled in the art in light of the above teachings. It is therefore to be understood that changes may be made in the particular embodiments disclosed that are within the scope and sprit of the disclosure as defined by the appended claims and equivalents.

What is claimed is:

1. Current control circuitry for controlling current supplied from a source to a load and a battery, the circuitry comprising:
a circuit path for interconnecting the source and the load;
a first circuit configured for limiting current on the circuit path within a predetermined amount; and
a second circuit, through which the battery is connected to the circuit path, configured for monitoring a voltage on the circuit path, and in response controlling an amount of current from the circuit path to the battery so as to maintain the current on the circuit path within the predetermined amount.

2. The current control circuitry according to claim 1, wherein
the source is a limited current capacity source.

3. The current control circuitry according to claim 1, wherein
the second circuit is configured for monitoring a voltage drop from the source to the load, and reducing the amount of the current to be supplied to the battery when the voltage drop exceeds a predetermined voltage.

4. The current control circuitry according to claim 3, wherein
the second circuit is configured for completely turning off the current to be supplied to the battery according to the voltage drop.

5. The current control circuitry according to claim 1, wherein
the second circuit is configured for monitoring a voltage of the load, and reducing the amount of the current to be supplied to the battery when the load voltage drops below a predetermined voltage.

6. The current control circuitry according to claim 5, wherein
the second circuit is configured for completely turning off the current to be supplied to the battery according to the load voltage.

7. The current control circuitry according to claim 1, wherein
the second circuit is further configured for monitoring a voltage of the battery, and reducing the amount of the current to be supplied to the battery when the battery voltage reaches a predetermined voltage.

8. The current control circuitry according to claim 1, wherein
the second circuit is further configured for monitoring a voltage of the load and a voltage of the battery, and enabling the battery to provide current to the load when the load voltage drops below the battery voltage.

9. The current control circuitry according to claim 1, further comprising
a detector for detecting presence of an additional source connected to the circuit path for supplying current to the load and battery, wherein
the first circuit is further configured for turning off the current from the source when the presence of the additional source is detected, for allowing the additional source to supply the current to the load and battery.

10. The current control circuitry according to claim 9, wherein
the additional source is a wall adaptor.

11. Current control circuitry for controlling current from a source to a load and a battery, the circuitry comprising:
a circuit path for interconnecting the source and the load;
a first circuit configured for limiting current on the circuit path within a predetermined amount;
a second circuit configured for monitoring a voltage on the circuit path; and
a third circuit, through which the battery is connected to the circuit path, configured for controlling an amount of current from the circuit path to the battery so as to maintain the current on the circuit path within the predetermined amount according to the voltage on the circuit path being monitored by the second circuit.

12. The current control circuitry according to claim 11, wherein
the source is a limited current capacity source.

13. The current control circuitry according to claim 11, wherein
the second circuit is configured for monitoring a voltage drop from the source to the load, and
the third circuit is configured for reducing the amount of the current to be supplied to the battery when the voltage drop exceeds a predetermined voltage.

14. The current control circuitry according to claim 13, wherein
the third circuit is configured for completely turning off the current to be supplied to the battery according to the voltage drop.

15. The current control circuitry according to claim 11, wherein
a second circuit is configured for monitoring a voltage of the load, and
the third circuit is configured for reducing the amount of the current to be supplied to the battery when the load voltage drops below a predetermined voltage.

16. The current control circuitry according to claim 15, wherein
the third circuit is configured for completely turning off the current to be supplied to the battery according to the load voltage.

17. The current control circuitry according to claim 11, further comprising
a fourth circuit configured for monitoring a voltage of the battery, wherein
the third circuit is configured for reducing the amount of the current to be supplied to the battery when the battery voltage reaches a predetermined voltage.

18. The current control circuitry according to claim 11, further comprising
a fourth circuit configured for monitoring a voltage of the load and a voltage of the battery, and
a fifth circuit configured for enabling the battery to provide current to the load when the load voltage drops below the battery voltage.

19. The current control circuitry according to claim 11, further comprising
a detector for detecting presence of an additional source connected to the circuit path for supplying current to the load and battery, wherein
the first circuit is further configured for turning off the current from the source when the presence of the additional source is detected, for allowing the additional source to supply the current to the load and battery.

20. Current control circuitry for controlling current from a source to a load and a battery, the circuitry comprising:
a circuit path for interconnecting the source and the load;
a first circuit configured for limiting current on the circuit path within a predetermined amount; and
a second circuit, through which the battery is connected to the circuit path, configured for monitoring a voltage on the circuit path, and in response controlling an amount of current from the first circuit to the battery so as to maintain the current on the circuit path within the predetermined amount, wherein
the first circuit includes a current limit control FET, which attains a high impedance once current on the circuit path reaches the predetermined amount, thereby causing the voltage on the circuit path to drop below an internally set threshold.

21. Current control circuitry for controlling current from a source to a load and a battery, the circuitry comprising:
a circuit path for interconnecting the source and the load;
a first circuit including a current limit control FET for limiting current on the circuit path within a predetermined amount, the control FET which attains a high impedance once current on the circuit path reaches the predetermined amount, thereby causing the voltage on the circuit path to drop;
a second circuit configured for monitoring a voltage drop of the control FET; and
a third circuit, through which the battery is connected to the circuit path, configured for reducing an amount of current from the circuit path to the battery so as to maintain the current on the circuit path within the predetermined amount when the voltage drop exceeds a predetermined voltage.

22. The current control circuitry according to claim 21, wherein
the source is a limited current capacity source.

23. The current control circuitry according to claim 22, wherein
the source is a USB (universal serial bus) power supply, and
the load and battery constitute a USB powered peripheral device.

24. The current control circuitry according to claim 21, further comprising
a fourth circuit configured for monitoring a voltage of the load, wherein
the third circuit is further configured for reducing the amount of the current to be supplied to the battery when the load voltage drops below a first predetermined voltage.

25. The current control circuitry according to claim 24, further comprising
a fifth circuit configured for monitoring a voltage of the battery, wherein
the third circuit is further configured for reducing the amount of the current to be supplied to the battery when the battery voltage reaches a predetermined voltage.

26. The current control circuitry according to claim 25, further comprising
a sixth circuit configured for monitoring a voltage of the load and a voltage of the battery, wherein
a third circuit is further configured for enabling the battery to provide current to the load when the load voltage drops below the battery voltage.

27. The current control circuitry according to claim 26, further comprising
a detector for detecting presence of an additional source connected to the circuit path for supplying current to the load and battery, wherein
the first circuit is further configured for turning off the current from the source when the presence of the additional source is detected, for allowing the additional source to supply the current to the load and battery.

28. The current control circuitry according to claim 27, wherein
the additional source is a wall adaptor.

29. A current control method for controlling current supplied from a source to a load and a battery, in which a circuit path interconnects the source and the load, and the battery is connected to the circuit path through a battery current control circuit for controlling current to the battery, the method comprising the steps of:
limiting current on a circuit path for interconnecting the source and the load within a predetermined amount; and
monitoring a voltage on the circuit path, and in response controlling an amount of current from the circuit path to the battery through the battery current control circuit so as to maintain the current on the circuit path within the predetermined amount.
